(19) United States
(12) Patent Application Publication
(10) Pub. No.: US 2014/0188772 A1
(43) Pub. Date: Jul. 3, 2014

(54) COMPUTER-IMPLEMENTED METHODS AND SYSTEMS FOR DETECTING A CHANGE IN STATE OF A PHYSICAL ASSET

(71) Applicant: GENERAL ELECTRIC COMPANY, Schenectady, NY (US)

(72) Inventors: Dustin Ross Garvey, Albany, NY (US); Neil Holger White Eklund, Schenectady, NY (US); Feng Xue, Clifton Park, NY (US)

(73) Assignee: GENERAL ELECTRIC COMPANY, Schenectady, NY (US)

(21) Appl. No.: 13/728,755

(22) Filed: Dec. 27, 2012

(51) Int. Cl. G06N 5/02

(52) U.S. Cl. CPC G06N 5/02
USPC 706/46

(57) ABSTRACT

A computer-implemented method for detecting a change in state of a physical asset is performed by a computer device. The computer device includes a processor and a memory device. The method includes receiving at least one input signal associated with the physical asset in a time period. The time period includes a first period and a second period. The method further includes receiving at least one output signal associated with the physical asset in the time period. The method also includes generating a predicted estimate and estimate residuals based upon the at least one input signal. The method additionally includes determining estimation errors. The method also includes detecting a probability of change in state of the physical asset. The method further includes transmitting the probability of change in state of the physical asset to a servicer of the physical asset.

### BACKGROUND

The field of the invention relates generally to computer-implemented programs and, more particularly, to a computer-implemented system for detecting a change in state of a physical asset.

Known methods exist for detecting a change in state of physical assets. However, such methods face difficulties for a variety of reasons. First, determining the appropriate signals associated with the change in state of an asset is required. In order to determine the appropriate signals, a wide variety of potential signal candidates must be considered and assessed. Second, understanding the precise relationship between the signals and a condition state must be well understood. Some signals may be merely suggestive of a change in physical state, while others are determinative. Third, the signals may give false positives due to changes in the signal that are not indicative of the asset state. Fourth, a change in state of the asset may be indicative of a trend or a stopping point. Fifth, due to the interplay between signals and the system, it is difficult to devise a system that is durable across a variety of assets. Depending upon the domain, the implications of changes in signals may be quite varied. Accordingly, expert information is often relied upon.

Many known approaches to this class of problem have focused on identifying the changed state by using models that look for anomalous behavior. These have focused on looking for patterns indicative of an anomaly. Necessarily, such solutions require an analysis of the particular system, expert information, and thus become domain dependent.

### BRIEF DESCRIPTION

In one aspect, a computer-implemented method for detecting a change in state of a physical asset is provided. The method is performed by a computer device. The computer device includes a processor and a memory device coupled to the processor. The method includes receiving at least one input signal associated with the physical asset in a time period. The time period includes a first period and a second period. The method further includes receiving at least one output signal associated with the physical asset in the time period. The method also includes generating a predicted estimate and estimate residuals based upon the at least one input signal. The method additionally includes determining estimation errors. The method also includes detecting a probability of change in state of the physical asset. The method further includes transmitting the probability of change in state of the physical asset to a servicer of the physical asset.

In another aspect, a network-based system for detecting a change in state of a physical asset is provided. The system includes a computing device. The computing device includes a processor and a memory device coupled to the processor. The system also includes a central database associated with the computing device. The system additionally includes at least one input sensor associated with the physical asset. The input sensor is configured to generate at least one input signal associated with the physical asset. The system further includes at least one output sensor associated with the physical asset. The output sensor is configured to generate at least one output signal associated with the physical asset. The network-based system is configured to receive at least one input signal associated with the physical asset in a time period. The time period includes a first period and a second period. The network-based system is further configured to receive at least one output signal associated with the physical asset in the time period. The network-based system is additionally configured to generate a predicted estimate and estimate residuals based upon the least one input signal. The network-based system is also configured to determine estimation errors. The network-based system is further configured to detect a probability of change in state of the physical asset. The network-based system is also configured to transmit the probability of change in state of the physical asset to a servicer of the physical asset.

In a further aspect, a computer for detecting a change in state of a physical asset is provided. The computer includes a processor and a memory device coupled to the processor. The computer is configured to receive at least one input signal associated with the physical asset in a time period. The time period includes a first period and a second period. The computer is further configured to receive at least one output signal associated with the physical asset in the time period. The computer is also configured to generate a predicted estimate and estimate residuals based upon the at least one input signal. The computer is additionally configured to determine estimation errors. The computer is further configured to detect, based on the estimation errors, a probability of change in state of the physical asset. The computer is also configured to transmit the probability of change in state of the physical asset to a servicer of the physical asset.

### DRAWINGS

These and other features, aspects, and advantages will become better understood when the following detailed description is read with reference to the accompanying drawings in which like characters represent like parts throughout the drawings, wherein:

FIG. 1 is a schematic view of an exemplary network-based system for detecting a change in state of a physical asset;

FIG. 2 is a block diagram of an exemplary computing device that may be used with the network-based system shown in FIG. 1;

FIG. 3 is a flow chart of an exemplary process for detecting a change in state of a physical asset using the network-based system shown in FIG. 1;

FIG. 4 is flow chart of an exemplary process that facilitates the process for detecting a change in state of a physical asset, shown in FIG. 3, using the network-based system as shown in FIG. 1; and

FIG. 5 is a simplified flow chart of an exemplary method for detecting a change in state of a physical asset using the network-based system as shown in FIG. 1.

Unless otherwise indicated, the drawings provided herein are meant to illustrate key inventive features of the invention. These key inventive features are believed to be applicable in a wide variety of systems comprising one or more embodiments of the invention. As such, the drawings are not meant to include all conventional features known by those of ordinary skill in the art to be required for the practice of the invention.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

As used herein, the terms “software” and “firmware” are interchangeable, and include any computer program stored in memory for execution by devices that include, without limitation, mobile devices, clusters, personal computers, workstations, clients, and servers.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the term “real-time” refers to at least one of the time of occurrence of the associated events, the time of measurement and collection of predetermined data, the time to process the data, and the time of a system response to the events and the environment. In the embodiments described herein, these activities and events occur substantially instantaneously.

As used herein, the term “Bayesian analysis” and related terms, e.g., “Bayesian inferences” and “naïve Bayesian classification,” refer to a method of inference which considers the probability of an event in light of a prior probability and a likelihood function derived from existing relevant data. More specifically, Bayesian analysis considers a set of data preceding an outcome, determines what data from that set of data is relevant, and determines an outcome probability based upon the general likelihood of an outcome and the likelihood considering the relevant set of data. Also, Bayesian analysis allows for the constant updating of a predictive model with new sets of evidence. Many known models of applying Bayesian analysis exist including naïve Bayesian classification Bayesian log-likelihood functions. Moreover, as used herein, Bayesian analysis facilitates distinguishing the likelihood of change in state of a physical asset based upon input and output signal data.

As used herein, the term “computer” and related terms, e.g., “computing device”, are not limited to integrated circuits referred to in the art as a computer, but broadly refers to a microcontroller, a microcomputer, a programmable logic controller (PLC), an application specific integrated circuit, and other programmable circuits, and these terms are used interchangeably herein.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the term “signal” and related terms, e.g., “signals,” refers to a type of measurement data that is sensed by a sensor or a plurality of sensors on an asset within the fleet of physical assets. The signals may include, without limitation, data on the mechanical integrity of a component, data on the mechanical operation of a component, data on the chemical state of a component, data on the electrical conductivity of a component, data on the radiation signatures of a component, and data on the temperature of a component. Also, as used herein, signal data facilitates detecting a change in state of a physical asset.

As used herein, the phrase “state” and related phrases, e.g., “change in state of a physical asset,” refers to the type of behavior that is expected for a particular asset in particular conditions. Also, as used herein, state is determined based upon an evaluation of input and output signals in conjunction with predictive detectors and informs whether there is a change in state of a physical asset.

As used herein, the term “normal” and related terms, e.g., “normal state,” refers to a condition where an asset behaves in an expected manner when examining the relationship of input data, output data, and predicted outputs. Normal is used in contrast to trend, described below. Also, as used herein, normal states are used as a baseline to determine whether an asset has deviated from a normal state.

As used herein, the term “trend” and related terms, e.g., “trend state,” refers to a condition where an asset behaves in a non-normal manner when examining the relationships of input data, output data, and predicted outputs. Trend is used in contrast to normal, described above. Also, as used herein, trend states are indicative of a change in state from a normal state for an asset and the detector described herein seeks to identify such trend states.

As used herein, the term “data warehouse” and related terms, e.g., “data warehouse transformation”, refers to a centralized data storage facility that receives data from multiple separate data storage facilities. Data warehouses utilize one or a variety of methods to transform the received data to a standard format. These methods may include, without limitation, methods of extraction, loading, and transformation, methods of data normalization, and methods that utilize defined data structures to dynamically alter data types. Also, as used herein, data warehouses facilitate activities that include, without limitation, centralization of asset data to improve data access and efficiency of data processing.

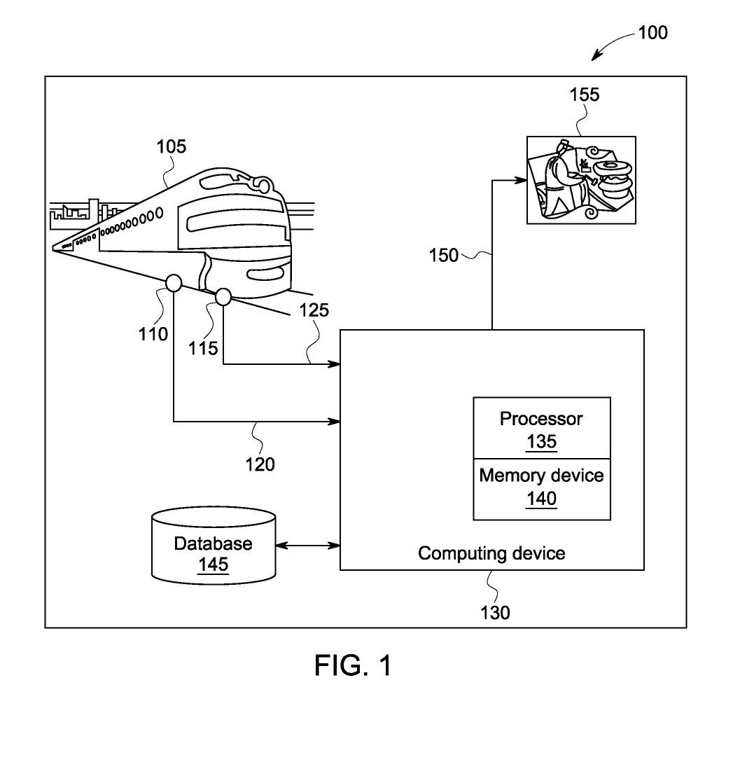

FIG. 1 is a schematic view of an exemplary network-based system 100 for detecting a change in state of a physical asset 105. Network-based system 100 includes a computing device 130. Computing device 130 includes a processor 135. Computer device 130 also includes a memory device 140. Memory device 140 and processor 135 are coupled to one another. Computing device 130 is further associated with a database 145. In the exemplary embodiment, database 145 is a data warehouse manifested as one database instance. In alternative embodiments, database 145 is a data warehouse manifested as a plurality of database instances.

Network-based system 100 further includes physical asset 105. In the exemplary embodiment, physical asset 105 is a locomotive. In alternative embodiments, physical asset 105 may include, without limitation, aircraft, watercraft, automobiles, trucks, communication devices, computing devices, manufacturing devices, or any other physical asset 105 capable of being used with network-based system 100.

Physical asset 105 is coupled to at least one input sensor 110 and at least one output sensor 115 where input sensor 110 is configured to send an input signal 120 and output sensor 115 is configured to send an output signal 125. In the exemplary embodiment, input sensor 110 measures water input into a vessel in locomotive 105. Further, output sensor 115 measures water flowing out of a vessel in locomotive 105. In alternative embodiments, input sensor 110 and output sensor 115 may include, without limitation, any sensors having an input-output relationship between input sensor 110 and output sensor 115 and where each sensor is associated with physical asset 105.

Network-based system 100 further includes a servicer 155 capable of providing maintenance, repair, diagnostic, and other services (not shown) to physical asset 105. Servicer 155 is capable of receiving a probability of change in state 150 of physical asset 105.

In operation, computing device 130 receives input signal 120 from input sensor 110. Computing device 130 further receives output signal 125 from output sensor 115. In the exemplary embodiment, computing device 130 stores input signal 120 and output signal 125 at database 145. In alternative embodiments, computing device 130 stores input signal 120 and output signal 125 in at least one of database 145, memory device 140, and external storage (not shown). Computing device 130 uses processor 135 to process input signal 120 and output signal 125 to determine probability of a change in state 150 of physical asset 105. Computing device transmits probability of a change in state 150 to servicer 155. In alternative embodiments, probability of a change in state 150 is transmitted to at least one of servicer 155, physical asset 105, and third-parties (not shown) capable of managing and controlling physical asset 105.

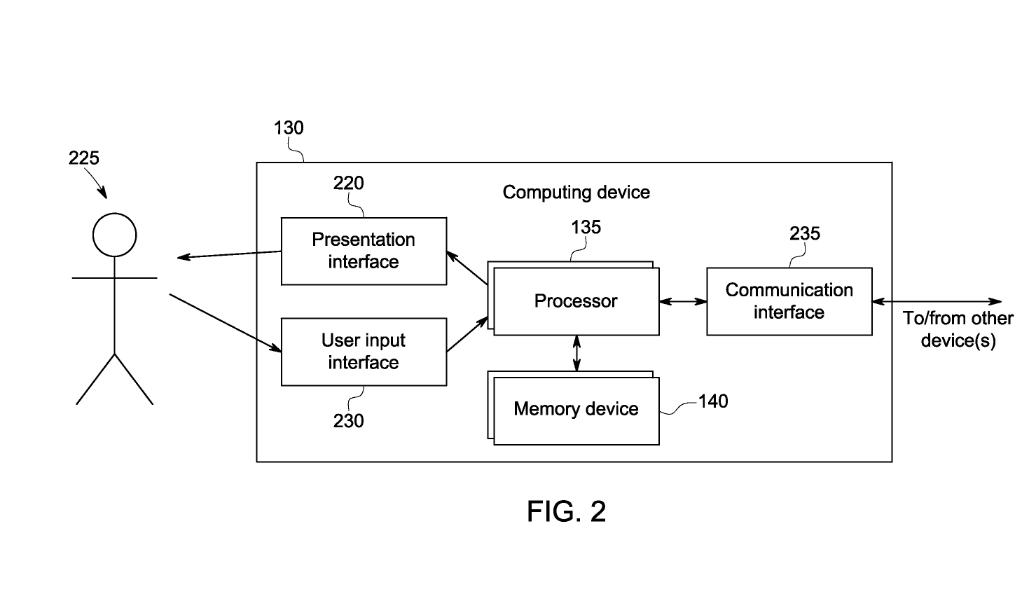

FIG. 2 is a block diagram of exemplary computing device 130 used for detecting a change in state of physical asset 105 (shown in FIG. 1). Computing device 130 includes a memory device 140 and a processor 135 operatively coupled to memory device 140 for executing instructions. In the exemplary embodiment, computing device 130 includes a single processor 135 and a single memory device 140. In alternative embodiments, computing device 130 may include a plurality of processors 135 and/or a plurality of memory devices 140. In some embodiments, executable instructions are stored in memory device 140. Computing device 130 is configurable to perform one or more operations described herein by programming processor 135. For example, processor 135 may be programmed by encoding an operation as one or more executable instructions and providing the executable instructions in memory device 140.

In the exemplary embodiment, memory device 140 is one or more devices that enable storage and retrieval of information such as executable instructions and/or other data. Memory device 140 may include one or more tangible, non-transitory computer-readable media, such as, without limitation, random access memory (RAM), dynamic random access memory (DRAM), static random access memory (SRAM), a solid state disk, a hard disk, read-only memory (ROM), erasable programmable ROM (EPROM), electrically erasable programmable ROM (EEPROM), and/or non-volatile RAM (NVRAM) memory. The above memory types are exemplary only, and are thus not limiting as to the types of memory usable for storage of a computer program.

Memory device 140 may be configured to store operational data including, without limitation, signal data (not shown), and/or any other type of data. In some embodiments, processor 135 removes or “purges” data from memory device 140 based on the age of the data. For example, processor 135 may overwrite previously recorded and stored data associated with a subsequent time and/or event. In addition, or alternatively, processor 135 may remove data that exceeds a predetermined time interval. Also, memory device 140 includes, without limitation, sufficient data, algorithms, and commands to facilitate operation of network-based system 100.

In some embodiments, computing device 130 includes a user input interface 230. In the exemplary embodiment, user input interface 230 is coupled to processor 135 and receives input from user 225. User input interface 230 may include, without limitation, a keyboard, a pointing device, a mouse, a stylus, a touch sensitive panel, including, e.g., without limitation, a touch pad or a touch screen, and/or an audio input interface, including, e.g., without limitation, a microphone. A single component, such as a touch screen, may function as both a display device of presentation interface 220 and user input interface 230.

A communication interface 235 is coupled to processor 135 and is configured to be coupled in communication with one or more other devices, such as a sensor or another computing device 130, and to perform input and output operations with respect to such devices. For example, communication interface 235 may include, without limitation, a wired network adapter, a wireless network adapter, a mobile telecommunications adapter, a serial communication adapter, and/or a parallel communication adapter. Communication interface 235 may receive data from and/or transmit data to one or more remote devices. For example, a communication interface 235 of one computing device 130 may transmit an alarm to communication interface 235 of another computing device (not shown). Communications interface 235 facilitates machine-to-machine communications, i.e., acts as a machine-to-machine interface.

Presentation interface 220 and/or communication interface 235 are both capable of providing information suitable for use with the methods described herein, e.g., to user 225 or another device. Accordingly, presentation interface 220 and communication interface 235 may be referred to as output devices. Similarly, user input interface 230 and communication interface 235 are capable of receiving information suitable for use with the methods described herein and may be referred to as input devices.

In the exemplary embodiment, user 225 may use computing device 130 by receiving information on physical asset 105 input signal data 120 (shown in FIG. 1) or output signal data 125 (shown in FIG. 1) via presentation interface 220. User 225 may act on the information presented and use computing device 130 to control or communicate with physical asset 105. User 225 may initiate such an action via user input interface 230 which processes the user command at processor 135 and uses communication interface 235 to communicate with other devices. These other devices may include, without limitation, plurality of servicer devices (not shown) associated with servicers 155 (shown in FIG. 1).

In the exemplary embodiment, computing device 130 is an exemplary embodiment of computing device 130 (shown in FIG. 1). In at least some other embodiments, computing device 130 is also an exemplary embodiment of other devices including plurality of client devices (not shown) and plurality of servicer client devices (not shown).

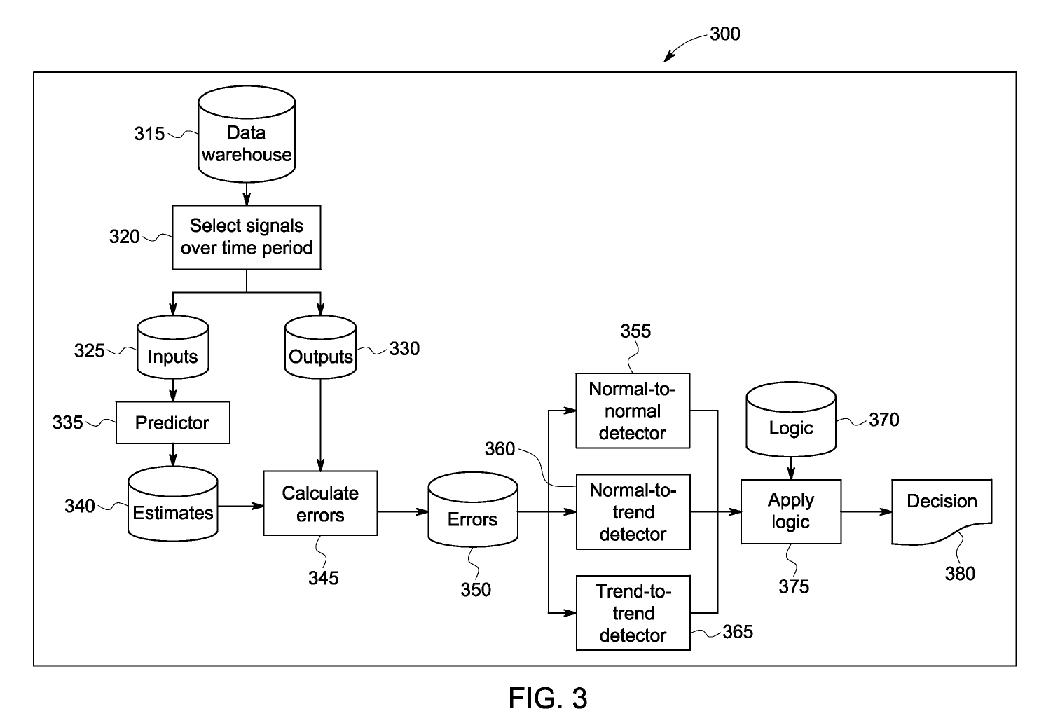

FIG. 3 is a flow chart of an exemplary process 300 for detecting a change in state of physical asset 105 using network-based system 100 (both shown in FIG. 1). Process 300 includes selecting signals over time period 320 from a data warehouse 315. In the exemplary embodiment, data warehouse 315 is representative of database 145 (shown in FIG. 1) coupled to computing device 130 (shown in FIG. 1) where database 145 includes input signal 120 (shown in FIG. 1) and output signal 125 (shown in FIG. 1). In alternative embodiments, data warehouse 315 may be database 145 (shown in FIG. 1) or any other data storage device (not shown) configured to store input signal 120 and output signal 125.

Further, process 300, separates selected 320 signals over time period into inputs 325 and outputs 330. In the exemplary embodiment, inputs 325 are input signals 120 generated by input sensor 110 coupled to physical asset 105. Outputs 330 are output signals 125 generated by output sensor 115 coupled to physical asset 105. Moreover, inputs 325 and outputs 330 represent data that has an input-output relationship related to an aspect of physical asset 105. Inputs 325 may include any data indicating an initial input condition including, without limitation, intake air pressure, incoming current through a circuit, and intake heat. Outputs 330 may include any data indicating an output condition related to an input condition including, without limitation, outflow air pressure, outgoing current through a circuit, and expelled heat.

Additionally, process 300 further includes applying predictor 335 to inputs 325 to create estimates 340. In the exemplary embodiment, predictor 335 represents at least one process (not shown) used to predict estimate 340 from input 325 where estimate 340 represents predicted output data based upon input 325. At least one process may include, without limitation, Bayesian analysis, adaptive modeling, and any predictive analysis algorithm.

Furthermore, process 300 includes using estimates 340 and outputs 330 to calculate 345 errors 350. In the exemplary embodiment, calculating 345 errors 350 represents comparing outputs 330 to estimates 340. Errors 350 are therefore representative of the accuracy of predictor 335 as they compare values determined based upon applying predictor 335 to inputs 325 with outputs 330. Errors 350 generally represent the deviation of predicted estimates 340 from outputs 330.

Also, process 300 applies at least some of errors 350, inputs 325, outputs 330, and estimates 340 to several detectors configured to determine a change in state of physical asset 105. Detectors include a normal-to-normal detector 355, a normal-to-trend detector 360, and a trend-to-trend detector 365. In the exemplary embodiment, detectors represent algorithmic programs designed to determine trend patterns for physical asset 105 based upon selected signal data over a time period 320.

Normal-to-normal detector 355 is used to determine whether errors 350 associated with inputs 325 and outputs 330 for physical asset 105 are indicative of asset 105 beginning the time period in a normal state and concluding it in a normal state. In the exemplary embodiment, normal state represents asset 105 performing to pre-defined acceptable levels of service. In alternative embodiments, normal state represents 105 asset performing to user determined (not shown) acceptable levels of service where a user 225 (shown in FIG. 2) may update levels of service at any point using computing device 130 (shown in FIG. 1).

Normal-to-trend detector 360 is used to determine whether errors 350 associated with inputs 325 and outputs 330 for physical asset 105 are indicative of asset 105 beginning the time period in a normal state and concluding it in a trending state. In the exemplary embodiment, trending state indicates that the state of physical asset 105 is moving away from a normal state. In the exemplary embodiment, the distinction between normal state and trending state is pre-defined. In alternative embodiments, distinction between normal state and trending state may be configured by a user 225 setting such distinctions at computing device 130.

A trend-to-trend detector 365 is used to determine whether errors 350 associated with inputs 325 and outputs 330 for physical asset 105 are indicative of asset 105 beginning the time period in a trending state and concluding it in a trending state.

Furthermore, process 300 further includes applying 375 logic 370 to the results of normal-to-normal detector 355, normal-to-trend detector 360, and trend-to-trend detector 365 to decide 380 the state of physical asset 105. In the exemplary embodiment, logic 370 is defined by user 225 specifying logic parameters (not shown). Logic parameters (not shown) may include, without limitation, which detectors should be used or ignored, inputs or outputs to ignore or include, or a minimum or maximum interval for the time period. In alternative embodiments, logic parameters may be determined by machine learning (not shown) or a combination of human knowledge (not shown) and machine learning (not shown).

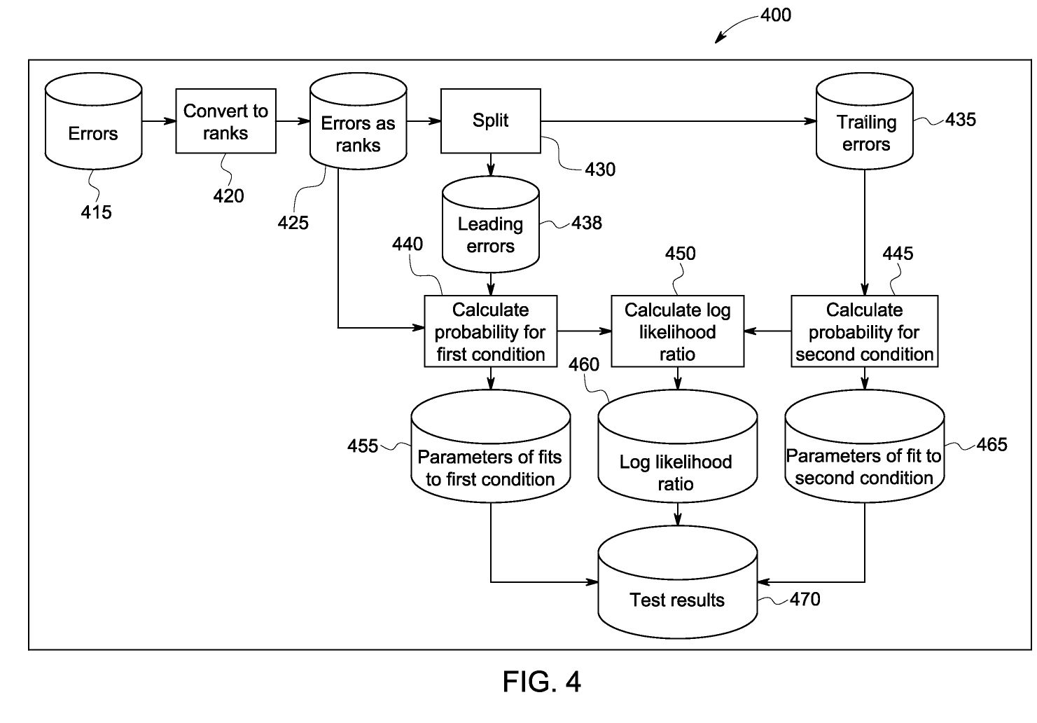

FIG. 4 is flow chart of an exemplary process 400 that facilitates process 300 (shown in FIG. 3) for detecting a change in state of a physical asset using network-based system 100 (shown in FIG. 1). Process 300 includes receiving errors 415 and converting 420 errors 415 to ranks 425. In the exemplary embodiment, errors 415 are representative of errors 350 (shown in FIG. 3) calculated 345 (shown in FIG. 3) by comparing outputs 330 (shown in FIG. 3) to estimates 340 (shown in FIG. 3). Ranks 425 are representative of an ordering of errors 415 based upon a pre-determined method. In the exemplary embodiment, ranks 425 are based upon a sorting of errors 415 numerically from least-to-greatest. In alternative embodiments, ranks 425 may be based upon, without limitation, any other mathematical or logical processing.

Furthermore, ranks 425 are split 430 into trailing errors 435 and leading errors 438. In the exemplary embodiment, trailing errors 435 represent ranks 425 obtained before split 430 where split 430 is based upon the time (not shown) associated with errors 415 that led to trailing errors 435. In contrast, leading errors 438 represent ranks 425 obtained after split 430 where split 430 is based upon the time (not shown) associated with errors 415 that led to leading errors 438.

Also, process 400 includes calculating a probability 440 for a first condition based upon leading errors 438 and errors as ranks 425. In the exemplary embodiment, calculating 440 the probability for the first condition represents applying at least one algorithm-based process to determine a probability of state of asset 105 in the time-period (not shown) before split 430. In the exemplary embodiment, calculating 440 the probability for the first condition represents calculating a probability for a first state of physical asset 105 where the first state may be normal or trending.

Moreover, process 400 includes calculating 445 a probability for a second condition based upon trailing errors 435. In the exemplary embodiment, calculating 445 the probability for the second condition represents applying at least one algorithm-based process to determine a probability of state of the asset 105 in the time-period (not shown) after split 430. In the exemplary embodiment, calculating 445 the probability for the second condition represents calculating a probability for a second state of physical asset 105 where the second state may be normal or trending.

Furthermore, process 400 includes calculating 450 a log-likelihood ratio 460 using calculated 440 probability for first condition and calculated 445 probability for second condition. In the exemplary embodiment, calculating 450 log-likelihood ratio 460 represents applying a statistical approach to determine the likelihood 460 the likelihood of a particular change in state. In alternative embodiments, this statistical approach may use any likelihood function including, without limitation, Bayesian reasoning, naïve Bayesian reasoning, and heuristically determined algorithms.

Additionally, parameters of fits to first condition 455 and parameters of fits to second condition 465 are determined based upon calculated 440 probability of the first condition and calculated 445 probability of the second condition, respectively. In the exemplary embodiment, parameters of fits to first condition 455 and parameters of fits to second condition 465 both represent the mathematical parameters of a function (not shown) establishing a relationship between inputs 325 (shown in FIG. 3), outputs 330 (shown in FIG. 3), calculated 440 probability of first condition, and calculated 445 probability of second condition.

Further, process 400 includes testing results 470 of log-likelihood ratio 460, parameters of fits to first condition 455, and parameters of fits to second condition 465. In the exemplary embodiment, testing results 470 represents applying programmatic analysis to determine the probability of a physical asset 105 following trend behavior expected based upon specifications for first condition and second condition. In the exemplary embodiment, tested results 470 may create results that can use applied logic 375 (shown in FIG. 3). Generally, process 400 describes an approach for using normal-to-normal detector 355 (shown in FIG. 3), normal-to-trend detector 360 (shown in FIG. 3), and trend-to-trend detector 365 (shown in FIG. 3).

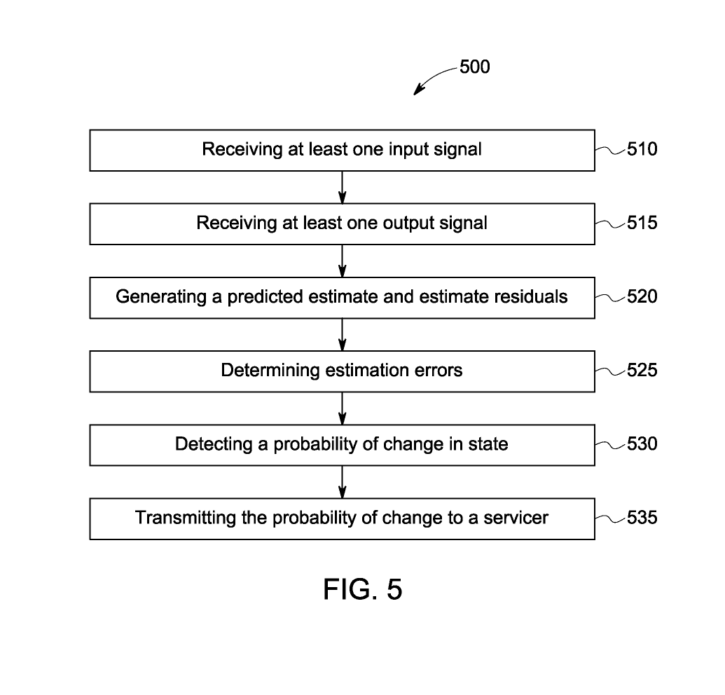

FIG. 5 is a simplified flow chart of an exemplary method 500 for determining the change in state of a physical asset 105 using a network-based system 100 (both shown in FIG. 1). Computing device 130 (shown in FIG. 1) receives 510 at least one input signal. In the exemplary embodiment, receiving 510 at least one input signal represents receiving input signal 120 (shown in FIG. 1) from input sensor 110 (shown in FIG. 1) associated with physical asset 105.

Also, computing device 130 receives 515 at least one output signal. In the exemplary embodiment, receiving 515 at least one output signal represents receiving output signal 125 (shown in FIG. 1) from output sensor 115 (shown in FIG. 1) associated with physical asset 105.

Furthermore, computing device 130 generates 520 a predicted estimate and estimate residuals. In the exemplary embodiment, generating 520 a predicted estimate and estimate residuals represents generating estimates 340 (shown in FIG. 3) using predictor 335 (shown in FIG. 3) on input signal 120 received from input sensor 110.

Additionally, computing device 130 determines 525 estimation errors. In the exemplary embodiment, determining 525 estimation errors includes comparing estimates 340 to outputs 330 (shown in FIG. 3) representative of output signal 125 and applying at least one algorithmic program to compare estimates 340 to outputs 330.

Further, computing device 130 detects 530 a probability of change in state of physical asset 105. In the exemplary embodiment, detecting 530 a probability of change in state represents applying at least one of normal-to-normal detector 355 (shown in FIG. 3), normal-to-trend detector 360 (shown in FIG. 3), and trend-to-trend detector 365 (shown in FIG. 3) to estimates 340 and outputs 330. Detecting 530 further includes applying logic 375 (shown in FIG. 3) to obtain decision 380 (shown in FIG. 3).

Moreover, computing device 130 transmits 535 the probability of change to a servicer. In the exemplary embodiment, transmitting 535 the probability of change to a servicer represents sending probability of change in state 150 (shown in FIG. 1), associated with decision 380, to servicer 155 (shown in FIG. 1). Sending probability of change in state 150 represents sending an electronic mail message to servicer 155. In alternative embodiments, sending probability of change in state 150 includes, without limitation, SMS, telephonic communication, instant message, and any communication to servicer 155.

The computer-implemented systems and methods as described herein facilitate provide an efficient approach for the detection of change in state of a physical asset. The embodiments described herein facilitate creating a robust method of detecting a change from a normal state to a trending state. Also, the methods and systems described herein facilitate the creation of a change detection method that is not dependent upon user input, domain specificity, or any other external characteristics. Further, the methods and systems described herein will reduce the cost of managing physical assets due to the decreased need for customized change detection systems. Additionally, these methods and systems will enhance the overall performance of physical assets due to detection of the change in state of a physical asset before such a change in state results in degradation. Furthermore, the methods and systems described herein will increase the efficiency and performance of physical assets reduce the financial burdens of management thereof by driving such efficiency, reducing degradation, and detecting adverse changes.

An exemplary technical effect of the methods and computer-implemented systems described herein includes at least one of (a) reduced costs from servicing resulting from early identification of assets and asset components that are trending away from normal; (b) increased efficiency of assets and asset components resulting from early identification of assets and asset components that tare trending away from normal; and (c) reduced costs of service interruption caused by late identification of assets and asset components that are trending away from normal.

Exemplary embodiments of computer-implemented systems detecting a change in state of a physical asset are described above in detail. The computer-implemented systems and methods of operating such systems are not limited to the specific embodiments described herein, but rather, components of systems and/or steps of the methods may be utilized independently and separately from other components and/or steps described herein. For example, the methods may also be used in combination with other enterprise systems and methods, and are not limited to practice with only the systems and methods for detecting a change in state of a physical asset as described herein. Rather, the exemplary embodiment can be implemented and utilized in connection with many other enterprise applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for detecting a change in state of a physical asset, wherein said method is performed by a computer device, the computer device including a processor and a memory device coupled to the processor, said method comprising:
receiving at least one input signal associated with the physical asset in a time period, the time period comprising a first period and a second period;
receiving at least one output signal associated with the physical asset in the time period;
generating, at the computer device, a predicted estimate and estimate residuals based upon said least one input signal;
determining, at the computer device, estimation errors;
detecting, at the computer device, based on said estimation errors, a probability of change in state of the physical asset; and
transmitting the probability of change in state of the physical asset to a servicer of the physical asset.

2. A method in accordance with claim 1, wherein said generating a predicted estimate comprises using kernel regression with the at least one input signal.

3. The method of claim 1, wherein said determining estimation errors comprises:
generating overall estimation errors by comparing said at least one output signal with said predicted estimate; and
converting overall estimation errors into overall estimation ranks.

4. The method of claim 3, further comprising:
generating, from said estimation errors, a leading estimate error sequence, said leading estimate error sequence substantially representative of estimate errors from the first period; and
generating, from said estimation errors, a trailing estimate error sequence, said trailing estimate error sequence substantially representative of estimate errors from the second period.

5. The method of claim 4, wherein detecting a probability of change in state of the physical asset comprises:
creating a first statistical model by applying a first statistical distribution to said leading estimate error sequence and said overall estimation ranks;
creating a second statistical model by applying a second statistical distribution to said trailing estimate error sequence; and
applying a log likelihood ratio to said first statistical model and said second statistical model.

6. The method of claim 5, wherein detecting a probability of change in state of the physical asset further comprises at least one of:
determining, based upon said log likelihood ratio, a probability that the physical asset was in a normal state in the first period and a normal state in the second period;
determining, based upon said log likelihood ratio, a probability that the physical asset was in a normal state in the first period and an abnormal trending state in the second period; and
determining, based upon said log likelihood ratio, a probability that the physical asset was in an abnormal trending state in the first period and an abnormal trending state in the second period.

7. The method of claim 6, wherein said log likelihood ratio must meet a minimum user defined threshold.

8. A network-based system for detecting a change in state of a physical asset, said system comprising:
a computing device including a processor and a memory device coupled to said processor;
a central database associated with said computing device;
at least one input sensor associated with the physical asset, said input sensor configured to generate at least one input signal associated with the physical asset; and
at least one output sensor associated with the physical asset, said output sensor configured to generate at least one output signal associated with the physical asset, said network-based system configured to:
receive at least one input signal associated with the physical asset in a time period, the time period comprising a first period and a second period;
receive at least one output signal associated with the physical asset in the time period;
generate, at the computer device, a predicted estimate and estimate residuals based upon said least one input signal;
determine, at the computer device, estimation errors;
detect, at the computer device, based on said estimation errors, a probability of change in state of the physical asset; and
transmit the probability of change in state of the physical asset to a servicer of the physical asset.

9. A network-based system in accordance with claim 8, the system configured to generate a predicted estimate using kernel regression with the at least one input signal.

10. The network-based system of claim 8, the system configured to determine estimation errors further configured to:
generate overall estimation errors by comparing said at least one output signal with said predicted estimate; and
convert overall estimation errors into overall estimation ranks.

11. The network-based system of claim 10, further configured to:
generate, from said estimation errors, a leading estimate error sequence, said leading estimate error sequence substantially representative of estimate errors from the first period; and
generate, from said estimation errors, a trailing estimate error sequence, said trailing estimate error sequence substantially representative of estimate errors from the second period.

12. The network-based system of claim 11, the system configured to detect a probability of change in state of the physical asset further configured to perform at least one of:
create a first statistical model by applying a first statistical distribution to said leading estimate error sequence and said overall estimation ranks;
create a second statistical model by applying a second statistical distribution to said trailing estimate error sequence; and
apply a log likelihood ratio to said first statistical model and said second statistical model.

13. The network-based system of claim 12, the system configured to detect a probability of change in state of the physical asset further configured to:
determine, based upon said log likelihood ratio, a probability that the physical asset was in a normal state in the first period and a normal state in the second period;
determine, based upon said log likelihood ratio, a probability that the physical asset was in a normal state in the first period and an abnormal trending state in the second period; and
determine, based upon said log likelihood ratio, a probability that the physical asset was in an abnormal trending state in the first period and an abnormal trending state in the second period.

14. The network-based system of claim 13, wherein said log likelihood ratio must meet a minimum user defined threshold.

15. A computer for detecting a change in state of a physical asset, said computer comprises a processor and a memory device coupled to said processor, said computer configured to:
receive at least one input signal associated with the physical asset in a time period, the time period comprising a first period and a second period;
receive at least one output signal associated with the physical asset in the time period;
generate a predicted estimate and estimate residuals based upon said least one input signal;
determine estimation errors;
detect, based on said estimation errors, a probability of change in state of the physical asset; and
transmit the probability of change in state of the physical asset to a servicer of the physical asset.

16. A computer in accordance with claim 15, wherein said computer is configured to generate a predicted estimate using kernel regression with the at least one input signal.

17. The computer of claim 15, wherein said computer configured to determine estimation errors further comprises:
generate overall estimation errors by comparing said at least one output signal with said predicted estimate; and
convert overall estimation errors into overall estimation ranks.

18. The computer of claim 17, further configured to:
generate, from said estimation errors, a leading estimate error sequence, said leading estimate error sequence substantially representative of estimate errors from the first period; and
generate, from said estimation errors, a trailing estimate error sequence, said trailing estimate error sequence substantially representative of estimate errors from the second period.

19. The computer of claim 18, wherein the computer configured to detect a probability of change in state of the physical asset is further configured to:
create a first statistical model by applying a first statistical distribution to said leading estimate error sequence and said overall estimation ranks;
create a second statistical model by applying a second statistical distribution to said trailing estimate error sequence; and
apply a log likelihood ratio to said first statistical model and said second statistical model.

20. The computer of claim 19, wherein the computer configured to detect a probability of change in state of the physical asset is further configured to perform at least one of:
determine, based upon said log likelihood ratio, a probability that the physical asset was in a normal state in the first period and a normal state in the second period;
determine, based upon said log likelihood ratio, a probability that the physical asset was in a normal state in the first period and an abnormal trending state in the second period; and
determine, based upon said log likelihood ratio, a probability that the physical asset was in an abnormal trending state in the first period and an abnormal trending state in the second period.
